(19) United States
(12) Patent Application Publication
(10) Pub. No.: US 2007/0182576 A1
(43) Pub. Date: Aug. 9, 2007

(54) Remote battery monitoring

(75) Inventors: Michael A. Proska, Oakville (CA); James R. Edwards, Mississauga (CA)

Correspondence Address: MITCHELL P. BROOK;C/O LUCE, FORWARD, HAMILTON & SCRIPPS LLP, 11988 EL CAMINO REAL, SUITE 200, SAN DIEGO, CA, 92130, US

(73) Assignee: 1673892 Ontario, Inc.

(21) Appl. No.: 11/351,382

(22) Filed: Feb. 9, 2006

(51) Int. Cl. G08B 21/00; G08B 1/08

(52) U.S. Cl. 340/636.1; 340/539.1

(57) ABSTRACT

A battery information collection system for collecting information on one or more batteries in use at a first site. The system comprises a data collection unit associated with each of the one or more batteries, the data collection unit including a sensor coupled to the battery associated therewith and a transmitter for sending battery operating data to a receiver. One or more controllers receive the battery operating data for a plurality of batteries and generate notifications upon detecting certain conditions.

### FIELD OF THE INVENTION

This application relates to remote battery monitoring.

### BACKGROUND OF THE INVENTION

Conventional battery monitoring systems typically provide the user of a particular industrial device with some indication of the level of charge remaining in the battery of that device. However, existing battery monitoring systems fail to provide status indications to centralized computers allowing for centralized monitoring of battery charge levels of devices in use in an industrial setting.

Accordingly, a system that provides improved battery monitoring functionality for battery powered industrial devices is desired.

### BRIEF SUMMARY OF THE INVENTION

Embodiments of the present invention provide a system and method for remote monitoring of battery assets within an organization.

One aspect of the present invention provides a battery information collection system for collecting information on a plurality of batteries in use at a first site. The system includes, for each battery, an associated data collection unit having at least one sensor coupled to the battery for sensing an operating characteristic thereof, and a wireless transmitter for wirelessly transmitting signals that include operating data representative of the sensed operating characteristic and identification information that can be used to uniquely identify the battery. The system also includes at least one site wireless receiver located at the first site for receiving from at least some of the data collection units the signals transmitted thereby including the operating data and identification information; and a controller connected by a communications link to the at least one site receiver for receiving therefrom the operating data and identification information for a plurality of the data collection units.

Another aspect of the present invention provides for a a battery information data collection unit for use with a rechargeable battery, the unit including at least one sensor coupled to the battery for measuring over time at least one operating characteristic of the battery; a processor connected to the one or more sensors for receiving the measured operating characteristic and generating battery operating data representative of the measured operating characteristic; a storage element connected to the processor for storing the battery operating data; and a wireless transmitter connected to the processor for communicating the battery operating data to a receiver.

Yet another aspect of the present invention an automated method for collecting battery information for battery powered devices operating at a site having at least one wireless receiver for receiving wirelessly transmitted information from a plurality of data collection units each associated with a respective battery located within a coverage area of the wireless receiver, the method including periodically receiving through the wireless receiver battery operating data transmitted from at least some of the data collection units, the battery operating data received from each data collection unit being representative of an operational status of the battery associated therewith; and monitoring the received battery operating data to detect at least one condition indicating that maintenance activity in respect of one or more of the batteries is required and if the at least one condition is detected, generating a notification message for the one or more batteries.

Other aspects and features of the present invention will be apparent to those of ordinary skill in the art from a review of the following detailed description when considered in conjunction with the drawings.

### BRIEF DESCRIPTION OF THE DRAWINGS

Reference will now be made to the drawings, which show by way of example, embodiments of the invention, and in which:

FIG. 1 is a schematic block diagram of a system for tracking and managing battery charge level and usage information for battery powered industrial devices;

FIG. 2 is a schematic block diagram of an example of a data collection unit used in the system of FIG. 1; and

FIG. 3 shows in flowchart form an embodiment of a method for tracking and managing battery charge level and usage information.

### DETAILED DESCRIPTION OF EXAMPLE EMBODIMENTS

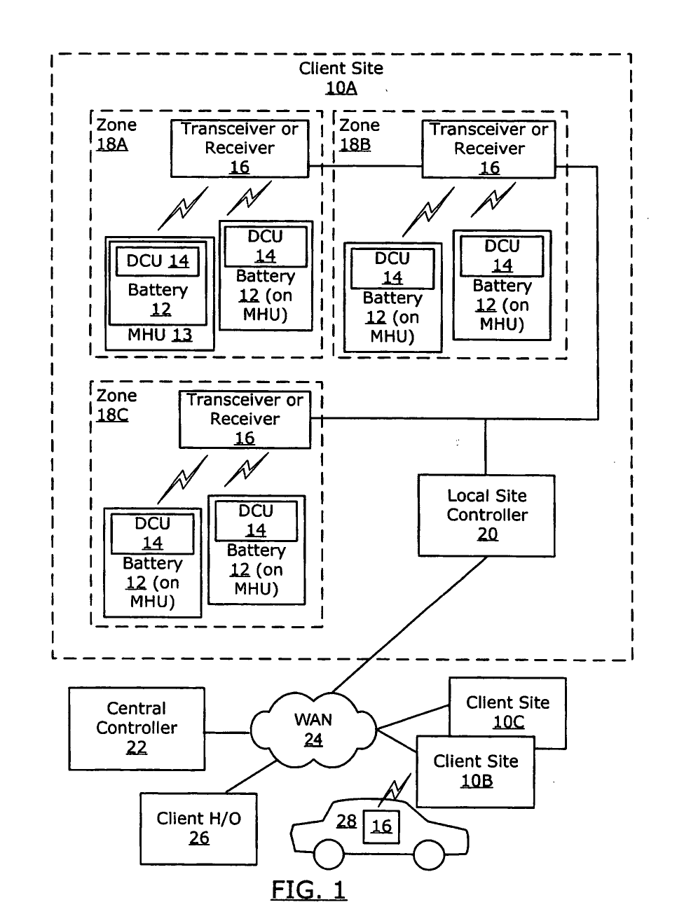

With reference to FIG. 1, a brief overview of a system for tracking and managing battery charge level and usage information for battery powered industrial devices will be provided. In one embodiment, the battery powered industrial devices comprise Material Handling Units 13 (MHUs). The MHUs include mobile industrial units that are used to move materials, including by way of non-limiting example, fork lifts, lift trucks, motorized hand carts, walkies, stackers, and pallet trucks. The MHUs 13 each include at least one battery 12 that has an on-board Data Collection Unit (DCU) 14 for tracking usage information about the battery 12. In one embodiment, the DCU 14 is configured to track and manage battery charge level and possibly other usage information. The DCU 14 may either be mounted on the MHU or permanently or removably mounted on and coupled directly to the battery 12. In one embodiment, each MHU has its own DCU 14 for monitoring one or more batteries in use on the MHU such that the DCU 14 remains with the MHU when the batteries 12 are changed. In such an implementation, the DCU 14 may have the ability to perform a software lookup from a local or central controller for information relating to the attached battery 12. In another embodiment, each battery 12 has a dedicated DCU 14 mounted to it such that the same DCU 14 remains with a particular battery 12 when the battery 12 is changed among different MHUs. As will be described further below, in an embodiment, the DCUs 14 are each enabled through active Radio Frequency Identification (RFID) technology to transmit the battery charge level and usage information to transceivers 16, as well as the location of the battery 12. Typically, each battery 12 will be associated with a particular client site (referenced herein individually as 10A, 10B and 10C and generally as 10).

In FIG. 1, a representative client site 10A is shown in greater detail, and may, for example, be a warehouse facility, a manufacturing facility, a retail facility, combinations of the forgoing, or another type of facility. In one embodiment, the client site 10A includes a number of different zones (referenced herein individually as 18A, 18B, and 18C and generally as 18) or areas in which the batteries 12 are present. For example, the zone 18A may be the primary warehouse area of the site 10A, the zone 18B the shipping/receiving area, and the zone 18C an outdoor area. In an example configuration, each zone 18 includes one or more receivers or transceivers 16 for periodically receiving information from the DCUs 14 of the batteries 12 located within the zone, and the transceivers 16 are in turn each connected to a local site controller 20, which may be implemented through a personal computer or server or other computing device. The site controller 20, which at least temporarily stores data received from site transceivers 16, may compile the received data and make it available to one or more users of the site controller 20. Additionally, the site controller 20 may perform some data analysis on the data. The site controller 20 is optionally connected through a communications link with a Wide Area Network (WAN) 24 (such as the Internet) with a central controller 22, which may be implemented by one or more servers or computer systems. The central controller 22 receives and processes data from the site controllers 20 located at each of the client sites 10, and provides processed data through a communications link with the WAN 24 to other client sites, such as a client head office 26. In some embodiments, service vehicles 28 equipped with transceivers 16 may be used to periodically capture data from the DCUs 14 of the batteries 12 that are at locations where there are no fixed transceivers 16, for example, at remote locations where there are few batteries 12 and it is not feasible to install permanent infrastructure for uploading the collected data. The information collected by the service vehicle 28 may then be uploaded, through one of the site transceivers 16 and/or through a cellular network or other networks, to the site controller 20 of a client site 10 when the vehicle 28 enters the site 10, or directly to the central controller 22.

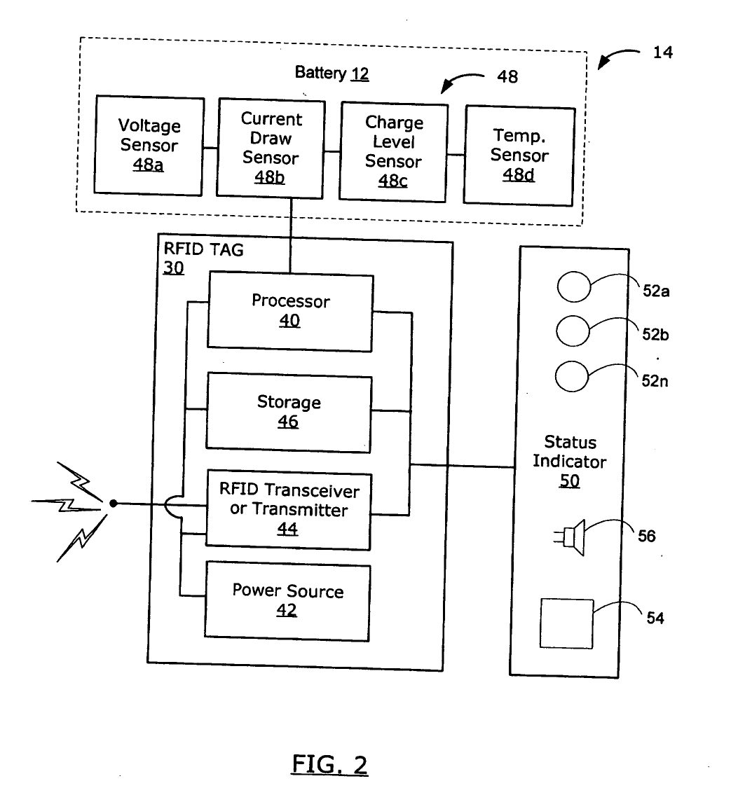

Referring to FIG. 2, features of the system for tracking and managing the battery charge level and usage information in battery powered industrial devices will now be described in greater detail. FIG. 2 shows an example of the DCU 14 for a battery 12 in greater detail. In one embodiment, the DCU 14 includes an active RFID TAG 30 that is configured to sense and track the battery charge or discharge state and related usage information of the battery 12 that hosts the DCU 14. The RFID TAG 30 generally includes a processor 40, a power source 42, an RFID transmitter or transceiver 44, and a storage device 46. In order to sense the battery operating conditions, the DCU 14 includes or receives inputs from one sensor or a number of sensors (referred to generally by reference number 48). Such sensors may include, for example, an operating voltage sensor 48a, an operating current draw (i.e., amperage) sensor 48b, a battery charge level sensor 48c, a temperature sensor 48d, etc. The voltage sensor 48a, operating current draw sensor 48b, and temperature sensor 48d provide real-time operating data about the battery 12, for example, in units of volts, amps, and degrees, respectively, while the charge level sensor 48c is an intelligent sensor that provides an approximation of the remaining charge left in the battery (e.g., in Amp-Hours). The data collection unit 14 may further include a status indicator 50 for showing the user of the battery 12 the battery charge status of the battery 12. The status indicator 50 includes a number status indicator lights 52a-n, individually indicated as 52a, 52b, . . . , 52n, and a button 54. The status indicator 50 may further have an optional audible warning device 56.

In operation, the battery 12 moves around, for example, the zone 18A at the client site 10A. The sensors 48a-d continuously monitor the state of the battery 12 and provide respective signals to the processor 40. In an example embodiment, the processor 40 is powered by the independent power source 42 so as not to make the reliable operation of the RFID TAG 30 dependent on the battery 12, such that the DCU 14 operates properly and reliably even when the battery 12 is low on charge or completely discharged. Alternatively, the power source 42 may function as a backup battery with the battery 12 providing the main source of power for the RFID TAG 30 and the battery 12 recharging the power source 42 as needed. The processor 40 may include one or more inputs having an analog to digital (A/D) converter for converting analog signals provided by the sensors 48a-d to digital signals that are processed and stored by the processor 40 in the storage device 46. The processor 40 uses the RFID transceiver 44 to periodically transmit the collected data to the transceiver 16, which is then relayed to the site controller 20. If there is a desire to manage the battery charge related information on an organization-wide basis, the site controller 20 may further share the collected data from all of the batteries 12 with the central controller 22 over the WAN 24. The consolidated data for client site 10A may then be available for analysis at the client head office 26, along with data from any other client site 10 connected to the WAN 24.

The RFID TAG 30 of each DCU 14 in use periodically provides the transceiver 16 with identity information and battery operating data of its respective battery 12. The DCU identity information and associated battery operating data is transmitted from transceivers 16 to the site controller 20, together with unique identity information of the transceiver 16. In at least one embodiment, the battery operating data is time stamped to show when in was sent by an RFID TAG 30 and/or received by a transceiver 16 and/or received by the site controller 20. Using the DCU identity information, battery operating data, transceiver identity information and time stamp information, the site controller 20 can track in real time or near real time a physical inventory of battery assets (e.g., the RFID TAG 30 associated with each battery 12 in use may provide to the transceiver 16 self-identification information such that the local controller 20 knows exactly which batteries 12 are in use at the site 10A), the real-time and historic location of the battery 12 while the battery 12 is within range of the transceivers 16 (in one embodiment, location information can be tracked by zones 18A-18C based on which transceiver 16 receives the data at a given time), and critical battery status notifications such as low battery conditions.

With respect to identity information, in one embodiment, the RFID TAG 30 of a DCU 14 will have a predetermined unique DCU ID associated with it (which may be stored in storage 46) that it can use to identify itself in transmissions. In embodiments where the DCU 14 is dedicated to a particular battery 14 (for example, the DCY 14 is mounted to, embedded in or otherwise secured permanently or semi-permanently to a particular battery), the unique DCU ID will be associated with that battery as long as the DCU 14 is secured to it, which may be for the life of the battery. The battery itself may have a further unique ID assigned to it, for example a serial number assigned by a supplier or manufacturer of the battery, and there can be a database at the client site 10A, or at the central controller 22, or elsewhere, in which the unique battery ID is linked to the unique DCU ID. For example, the battery may include a physically visible code (for example a alphanumeric code etched on the battery or on a plate attached to the battery, or a barcode) and the DCU 14 could include a similar visible barcode or etching, and the two numbers entered into a computer system by manual entry or barcode reader and linked together in a database when the DCU is first secure to the battery 12 to associate the DCU ID with the battery ID. Alternatively, identifying information for the battery could be embedded on a low cost passive RFID tag on the battery that could be read by an interrogator along with the DCU ID to perform the association. The battery ID (and also the DCU ID) can be linked by the controllers 20 or 22 to data such as the origin of the battery 12 and the date and time at which the battery 12 was manufactured, acquired and/or put into service.

In some example embodiments, when a battery 14 having a dedicated DCU 14 is mounted onto a particular MHU 13, an association procedure is carried out to associate the unique DCU and/or battery ID with a unique ID of the MHU 13. Such procedure may be carried out in any number of ways—for example the MHU 13 may have its own on-board data collection unit similar to DCU 14, and when the battery 12 is mounted on the MHU 13, at least one of the DCU 14 of the battery 12 and the data collection unit of MHU 13 transmits its unique ID to the other. Thus, in some embodiments, the battery operating data sent to a transceiver 16 can also include information identifying the particular MHU 13 that the battery 12 is mounted on at a given time. In some embodiments, the association procedure could require entry at a battery change station of ID information for the battery and/or DCU 14 and entry of ID information for the MHU 13, for example through number key entry or scanning of barcodes on the battery 12 and MHU 13 or reading of ID's embedded in the respective data collection units or other RFID tags of the battery 12 and MHU 13, with such entered data being provided to the local site controller 20. Accordingly, it will be appreciated that a battery 12 and its dedicated DCU 14 can be temporarily associated for tracking purposes with a particular MHU 13.

In some embodiments, the battery 12 may not have a dedicated DCU 14, but rather battery information is collected through a DCU 14 that is dedicated (eg. mounted to) a particular MHU 13 and which stays with the MHU when the battery leaves the MHU 13. In such case, the unique DCU ID (which will be the same as associated with an unique ID for the MHU 13) will only be associated with a particular battery so long as that battery is used on the particular MHU. In such an embodiment, when a battery is first placed on an MHU 13, an association procedure is carried out to associate, in an electronic database accessible to at least one of the controllers 20, 22, a unique battery ID for the battery with the unique DCU ID for the MHU 13. The association process may be carried out in any number or ways—each battery may, by way of example, have a passive RFID (Radio Frequency Identification) tag attached to it that passes a unique ID for the battery to the DCU 14 when the battery 12 is mounted to the MHU 12, thus temporarily associating an unique battery ID with the DCU 14 of a specific MHU 13. Alternatively, unique barcodes and or operator discernable identity codes can be physically provided on one or both of the battery 12 and the MHU/DCU that can be read by or physically entered into a workstation connected to controller 20.

The battery operating data, identification information and time stamp information collected from DCU's 14 and transceivers 16 may analyzed by the rt the site controller 20 and/or central controller 22 to detect conditions that vary from predetermined parameters and thus require some sort of action or intervention, including for example conditions that indicate, when compared by the site controller 20 and/or central controller 22 with predetermined profiles or thresholds, a low battery or that an operator is prematurely swapping the batteries 12 onto or off of different MHUs or prematurely charging the batteries 12. In one embodiment, the local controller 20 and/or the central controller 22 are enabled with the ability to trigger alarms or alerts using emails, pages, SMS messages, or other notifications when certain charging requirements or rules or guidelines are not followed. Such notifications will typically include the identity of at least one of the MHU, the DCU and the subject battery. In some systems, operator ID may be linked in a database to a particular MHU, enabling operator ID to be included in the notification and/or data tracked at the controller 20.

In one embodiment, if the battery 12 has a predetermined level of charge and either enters or leaves a transceiver's 16 range, an alert is triggered by controller 20 and/or the battery's DCU 14. In another embodiment, if a battery 12 from one area (e.g., the zone 18A) enters another area (e.g., the zone 18B), an alarm is triggered by controller 20 and/or DCU 14. This is useful in instances where safety concerns prevent a battery of one class from entering an area where such batteries are not permitted (e.g., some batteries are not rated for use in areas where there is a risk of explosion). An alarm can be raised if a battery of a certain class or type is mounted to a MHU type that the battery is not meant to be used with. Additionally, in one embodiment, the status indicator 50 responds to a push of the button 54 by providing the user of the battery 12 with extended condition reporting using the status indicator lights 52. The status indicator lights 52 may be configured to report any desired conditions to the user, such as battery charged condition, a low battery condition, a critical battery condition, etc. In another embodiment, the status indicator lights 52 may always be on indicating current operating conditions. The audible alarm 56 may also be used to indicate current conditions using various beeping codes or voice recordings or voice synthesis technology. In some embodiments, at least some of the processing of data received from sensors 48a-d to determine a current battery condition may be done locally on the processor 40 of a DCU 14—for example, the inputs from one or more sensors 48-48c could be compared against thresholds to determined if the battery is in a low change state, and if so the appropriate status indicator light 52 activated and an alert message sent to the controller 20. In some embodiments, the sensor data processing done locally on processor 40 is minimal, and just raw sensor data is sent to the local site controller 20 for processing there. In such embodiments, the controller 20 may detect the low battery condition and send an alert message back to the DCU 14 causing the appropriate status indicator light 52 to be activated.

In some embodiments, the time at which a battery is charged may be determined based on the data received by the controller 20 from a battery DCU—for example, a spike in the battery charge level in a short duration may be interpreted by the controller as indicative of a battery charging. In some embodiments, the battery charge station may be equipped with a transceiver 16 or other mechanism for receiving identification information from a battery that is being charged, and the charge station may include a workstation connected to the controller 20 to advise the controller that charging of a particular battery is occurring or has occurred.

In example embodiments, the site controller 20 saves and compiles over time information (for example a battery data record) for each battery 12 in use within the client site 10A including at least some of the following: the date, time, place and purchase of the battery, the battery's cumulative time in service, statistics related to typical battery charge and discharge times and charge and discharge profiles, battery operating temperatures, the time since the last charge and the projected remaining time in service of the battery 12 until a charge is needed, etc. The site controller 20 also generates special notifications or alerts such as low battery power indications. The site controller 20 runs a suitable software package to compile this information and make the information available to the user of the site controller 20 in a manageable and easy to view fashion. Using the site controller 20, a site manager of the client site 10A receives alerts and/or reports (for example, through a display screen or printer connected to the site controller workstation 20, or through a work station connected by a communications link to controller 20, or through a wireless devices connected directly or indirectly by a wireless communications link to controller 20) about batteries 12 that may be approaching low charge or discharged states prematurely (e.g., before scheduled charging times) and the current location of the associated MHUs such that action can be taken before MHUs with insufficient charge to complete scheduled service time spans become disabled. Additionally, the site controller 20 allows a site manager to view information about all of the batteries 12 in use at the client site 10A including associated information such as the cumulative time in use and projected remaining life span of the batteries 12 allowing the site manager to plan for future battery upgrades or retrofits and associated expenditures. All or selected information from the electronic battery operating data records that are created and maintained for the batteries 12 may be transmitted to the central controller 22, thus making the information accessible to the client head office 26. As such, data for all the batteries 12 in use across the client's organization (e.g., the client sites 10A, 10B, and 10C) may be viewed together using one interface. In various embodiments, some or all of the data storage and analysis discussed above in respect of local site controller 20 can be performed at central controller 22. In some embodiments, a site controller 20 may also include the functionality of a central controller 22. Furthermore, in some embodiments, the functionality of the controllers 20 and 22 may be distributed among several workstations or servers.

As suggested above, in some embodiments information is mined from the cumulative battery operating data records to generate an electronically stored benchmarking database of benchmark thresholds and profiles against which the performance of individual batteries can be measured. For example, the data contained in a battery operating data record for each or selected batteries can be compared against the generated thresholds and profiles to detect conditions that are indicative of problems with individual batteries—for example if a particular battery requires more frequent charging than a threshold amount determined in dependence on average battery charging data, a flag can be raised; if the battery charge level profile for a battery over a duration of time varies more than a threshold amount from an average charge level profile, then a flag can be raised; if a battery has a temperature profile over a duration of time that varies more than a threshold amount from an average temperature profile, then a flag can be raised; if the battery current draw profile over a duration of time varies more than a threshold amount from an average current profile, then a flag can be raised; if a battery has a voltage profile over a duration of time that varies more than a threshold amount from an average voltage profile, then a flag can be raised. In some embodiments, the profiles and thresholds need not be based on actual collected battery operating data, but rather could be based on idealized or desired values. These types of analysis can be performed at any computer(s) having access to the battery operating data records and the thresholds database, including for example site controller 20 and/or central controller 22. The flags raised could include, among other things, visual alerts or notifications appearing on a computer screen and/or the display of a wireless device and/or computer generated printouts.

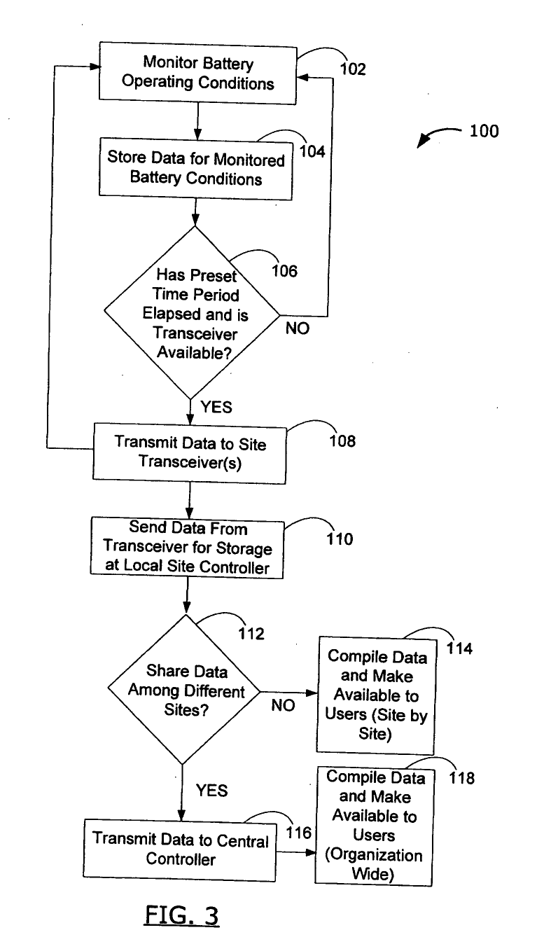

FIG. 3 shows a method 100 for monitoring, tracking, and managing battery charge level and usage information according to one embodiment of the present invention. As shown in FIG. 3, the first step, which is carried out at a DCU 14,is to monitor the battery operating conditions (step 102) using, for example, the sensors 48 (FIG. 2) at the location of the battery such as on the battery 12 (FIG. 1). Next, data is stored for the monitored battery conditions (step 104) such as in the storage device 46 (FIG. 2) by the processor 40. This storage may be either temporary, semi-permanent, or permanent, depending on the type of storage technology chosen for the storage device 46 (e.g., volatile RAM, non-volatile RAM, or hard disk). Next, at a decision block 106, it is determined whether a preset time period has elapsed and if a transceiver (e.g., the transceiver 16 shown in FIG. 1) is available. If the preset time has elapsed and the transceiver is available, the data is transmitted (e.g., by the RFID transceiver 44 shown in FIG. 2) to the site transceiver 16 (step 108). If either the preset time period has not elapsed or the transceiver is not available, the method 100 returns to the step 102. The preset time period may be any period chosen to meet the requirements of a particular application. In one embodiment, the time period may be very short, such as a fraction of a second. In another embodiment, the time period may be relatively long, such as a number of hours. In another embodiment, the DCU 14 transmits data in response to being polled by a transceiver 16, rather than or in addition to the periodic intervals. After the step 108, the transmitted data received by transceiver 16 sent to and stored at the local site controller (step 110) (e.g., the controller 20 shown in FIG. 1). The storage function performed by the step 110 is preferably semi-permanent or permanent in nature. The steps 102, 104, 106 and 108 are repeated in a continuous loop under the control of the DCU 14. The Step 110 is repeatedly performed by transceivers 16 and site controller 22. Steps 112, 114, 116, and 118 are executed by the site controller 20 and the central controller 22 At a decision step 112, it is determined whether there is to be data shared among different sites (e.g., between the client sites 10A, 10B, 10C, etc.). If there is not to be data shared among different sites, the data is compiled and made available to a user in a suitable form by the site controller 20 (FIG. 1) at a step 114. If there is to be data sharing among different sites, the data is further transmitted to a central controller (e.g., the central controller 22 shown in FIG. 1) at a step 116. Next, the data is compiled and made available to users of the organization in a suitable form (step 118). Data sharing at an organizational level uses appropriate data exchange infrastructures such as the WAN 24 shown in FIG. 1. Data presentation of the step 118 is available to any authorized user within the client sites 10A, 10B, 10C, or the headquarters 26, shown in FIG. 1. Off-site remote web-based access to the data through a workstation connected to the WAN 24 can also be provided in some embodiments.

Embodiments of the present invention can assist in providing tools useful for an organization to increase productivity, efficiency, and profitability by: (a) increasing the effective utilization of the batteries 12; (b) increasing battery life by reducing the number of charging cycles by ensuring that the batteries 12 are not charged until needed; (c) enabling the battery owners to put programs in place to extend battery lifecycles by providing the owners with a wealth of information about battery usage; (d) enabling battery owners to evaluate battery value by monitoring battery operating metrics (e.g., life cycle and durability) by battery brand, size, and type; and (e) saving time spent performing physical inventory checks.

While embodiments of the present invention are described above within the context of active RFID known to those skilled in the art, it will be understood that embodiments of the present invention may be implemented using any known wireless communications mechanism, such as various ISM-license free and licensed bands including 433, 868, 900, 1200, 2400, 5800 MHz. The modulation technique is generally dependent on the band and the RFID TAG application requirements, but may include FM, QSPK, DSSS, FHSS, and other narrow and wide band modulation techniques.

The above-described embodiments of the present application are intended to be examples only. Alterations, modifications and variations may be effected to the particular embodiments by those skilled in the art without departing from the scope of the application, which is defined by the claims appended hereto.

I claim:

1. A battery information collection system for collecting information on a plurality of batteries in use at a first site, the system comprising:
for each battery, an associated data collection unit having at least one sensor coupled to the battery for sensing an operating characteristic thereof, and a wireless transmitter for wirelessly transmitting signals that include operating data representative of the sensed operating characteristic and identification information that can be used to uniquely identify the battery;
at least one site wireless receiver located at the first site for receiving from at least some of the data collection units the signals transmitted thereby including the operating data and identification information; and
a controller connected by a communications link to the at least one site receiver for receiving therefrom the operating data and identification information for a plurality of the data collection units.

2. The battery information collection system according to claim 1, wherein the at least one sensor is configured for sensing an operating characteristic that is indicative of a battery charge level, the operating data includes a representation of the battery charge level, and the controller is configured for tracking over time battery charge level information for at least some of the plurality of batteries.

3. The battery information collection system according to claim 2 wherein the controller is configured for generating a notification when the received operating data for at least one of the batteries indicates that a predetermined charge level thereof has fallen below a predetermined threshold, the notification including identification data uniquely identifying at least one of the battery, the data collection unit associated with the battery, or a material handling unit to which the battery is operatively mounted.

4. The battery information collection system according to claim 3 wherein the controller is configured to cause the notification to be sent to a wireless device.

5. The battery information collection system according to claim 1 wherein the controller is configured for determining and storing, at least partially in dependence on received operating data, a battery operating data record for each of the batteries, the operating data record for each battery indicating a battery charge level history for the battery over a duration of time.

6. The battery information collection system according to claim 5 wherein the controller is configured for comparing the battery charge level history for a subject battery with a predetermined battery operating profile and generating a notification if the comparison indicates that an actual operating profile of the subject battery is not within an acceptable range relative to the predetermined battery operating profile.

7. The battery information collection system according to claim 1 wherein the controller is configured for evaluating if the operating data received over time for a subject battery indicates that the ability of the subject battery to hold a charge falls below an acceptable performance level and, if so, generating a notification about the subject battery.

8. The battery information collection system according to claim 1 including a plurality of site wireless receivers located at the first site, each of the receivers having a respective coverage area for receiving from data collection units located in the respective coverage are the signals transmitted thereby, the controller being configured for tracking location information for the batteries based on an identification of the receiver through which the operating data and identification information for a subject battery is received.

9. The battery information collection system of claim 1 wherein the system is also for collecting information on a plurality of batteries in use at a second site, the system further comprising:
for each battery at the second site, an associated data collection unit having at least one sensor coupled to the battery for sensing an operating characteristic thereof, and a wireless transmitter for wirelessly transmitting signals that include operating data representative of the sensed operating characteristic and identification information that can be used to uniquely identify the battery;
at least one second site wireless receiver located at the second site for receiving from at least some of the data collection units at the second site the signals transmitted thereby including the operating data and identification information;
a second site controller connected by a communications link to the at least one site receiver for receiving therefrom the operating data and identification information for a plurality of the data collection units; and
a further controller connected by a communications network to the controller and the second site controller for receiving therefrom information about the operating data and identification information for a plurality of the data collection units at the first and second sites.

10. A battery information data collection unit for use with a rechargeable battery, the unit comprising:
at least one sensor coupled to the battery for measuring over time at least one operating characteristic of the battery;
a processor connected to the one or more sensors for receiving the measured operating characteristic and generating battery operating data representative of the measured operating characteristic;
a storage element connected to the processor for storing the battery operating data; and
a wireless transmitter connected to the processor for communicating the battery operating data to a receiver.

11. The battery information data collection unit according to claim 10, further comprising:
a status indicator connected to the processor including at least one of a light or an audible sound generator for indicating a charge status of the battery in dependence on the battery operating data.

12. The battery information data collection unit according to claim 10, wherein the at least one sensor is selected from the group consisting of a voltage sensor, a current draw sensor, a charge level sensor, and a temperature sensor.

13. The battery information data collection unit according to claim 10, wherein the data collection unit is physically secured to the battery.

14. The battery information data collection unit according to claim 10 wherein the data collection unit is physically secured to a material handling unit to which the battery is secured.

15. An automated method for collecting battery information for battery powered devices operating at a site having at least one wireless receiver for receiving wirelessly transmitted information from a plurality of data collection units each associated with a respective battery located within a coverage area of the wireless receiver, the method comprising:
periodically receiving through the wireless receiver battery operating data transmitted from at least some of the data collection units, the battery operating data received from each data collection unit being representative of an operational status of the battery associated therewith; and
monitoring the received battery operating data to detect at least one condition indicating that maintenance activity in respect of one or more of the batteries is required and if the at least one condition is detected, generating a notification message for the one or more batteries.

16. The method of claim 15 wherein the notification message is generated on at least one of a computer screen, a mobile device display, or a computer generated print out and includes information that identifying the one or more batteries for which the notification message is being generated and the nature of the condition for which the notification message is being generated.

17. The method of claim 15 wherein the maintenance activity includes at least one of charging a battery and replacing a battery.

18. The method of claim 15 further including:
storing in a computer accessible storage at least some of the received battery operating data to create a record of operating data for each battery; and
generating, in dependence on the operating data records for a plurality of the batteries, operating thresholds against which the operating data received from individual batteries can be is compared,
wherein monitoring the received battery operating data includes comparing the operating data received in respect of individual batteries against the operating thresholds.

19. The method of claim 15 including receiving an electronic identification of battery type for a battery, receiving an electronic identification of an battery operated device type, checking an electronic database to determine if the types are incompatible with each other and if so generating a notification.

20. The method of claim 15, wherein the battery operating data includes one or more of battery voltage, battery current draw, battery charge level, battery ambient temperature, battery temperature, and battery location at the site.
